(19) United States
(12) Patent Application Publication
(10) Pub. No.: US 2025/0114777 A1
(43) Pub. Date: Apr. 10, 2025

(54) A CATALYST AND A METHOD OF PREPARING THE SAME

(71) Applicant: AGENCY FOR SCIENCE, TECHNOLOGY AND RESEARCH, Singapore (SG)

(72) Inventors: Luwei CHEN, Singapore (SG); Chee Kok POH, Singapore (SG); Jie CHANG, Singapore (SG); Mingyao Kelvin KWOK, Singapore (SG); Pin LIM, Singapore (SG); Armando BORGNA, Singapore (SG)

(21) Appl. No.: 18/836,617

(22) PCT Filed: Feb. 8, 2023
(86) PCT No.: PCT/SG2023/050067

§ 371 Date: Aug. 7, 2024

(30) Foreign Application Priority Data
Feb. 8, 2022 (SG) 10202201204X

(51) Int. Cl. B01J 37/03; B01J 21/18; B01J 23/745; B01J 23/75; B01J 23/78; B01J 23/825; B01J 37/04; B01J 37/08

(52) U.S. Cl. CPC B01J 37/031; B01J 21/18; B01J 23/745; B01J 23/75; B01J 23/78; B01J 23/825; B01J 37/04; B01J 37/08

(57) ABSTRACT

There is provided a method of forming a catalyst precursor, including the steps of: (a) forming a precipitate from a slurry, wherein the slurry comprises (i) a mixture of an iron precursor, at least one promotor precursor and a solvent and (ii) a solution of an alkali base; and (b) calcining the precipitate to form the catalyst precursor. There is also provided a catalyst precursor; a method of forming a catalyst; and a catalyst.

### REFERENCES TO RELATED APPLICATION

This application claims priority to Singapore application number 10202201204X filed with the Intellectual Property Office of Singapore on Feb. 8, 2022, the contents of which are hereby incorporated by reference.

### TECHNICAL FIELD

The present invention generally relates to a method of forming a catalyst precursor. The present invention further relates to a catalyst precursor. The present invention further relates to a method of forming a catalyst. The present invention further relates to a catalyst. The present invention further relates to a process of converting COₓ and H₂ into hydrocarbons using the catalyst as described herein, wherein x is 1 or 2.

### BACKGROUND ART

Fischer-Tropsch synthesis (FTS) reaction offers an alternative pathway to produce fuels and chemicals from non-fossil oil-based feedstocks, such as coal, biomass, plastic wastes and CO₂. The synthesis process may be used to convert carbon monoxide/carbon dioxide and hydrogen into liquid hydrocarbons. Due to the usefulness of this process for the decarbonisation and renewable production of useful fuels, FTS has been studied extensively by researchers worldwide for nearly a century. However, the development of efficient and selective catalysts remains challenging.

While Hagg-carbide (Fe₅C₂) has generally been observed in catalysts prepared for the FTS process and is conventionally considered as the most useful active phase for the FTS process, ε-Fe₂C phase actually displays higher activity at lower temperatures, allowing for the FTS process to be used at milder conditions with a reduced energy consumption for industrial processes. However, the synthesis of Fe₂C for FTS is not straightforward as it is a considerably less stable phase of iron carbides. Conventional methods for the synthesis of iron-based catalysts for FTS generally produce Fe₅C₂ or a mixture of iron carbides as the catalytic active phase. A few conventional methods for the synthesis of ε-Fe₂C are known in the art. However, these methods require complex and tedious preparation procedures and are limited in scalability.

One conventional method for the synthesis of ε-Fe₂C involves alkali leaching and quenching with a single roller melt-spinning method for preparing a RQ-Fe alloy. The RQ-Fe alloy needs to be further leached and collected as a powder using a magnet, and washed multiple times with distilled water, ethanol and PEG200, before being stored and carburized with syngas to give rise to ε-Fe₂C. This process is rather complex and tedious, which does not allow efficient preparation of the catalyst.

Another conventional method is known for embedding nanocrystalline ε-Fe₂C in hollow carbon spheres (HCS) for better stability and selectivity for FTS. This method requires an initial fabrication of the HCS structure by applying the Stober methods to silica spheres before doping and aging for 24 hours, and subsequent static hydrothermal synthesis and washing. After completion of the above steps, excessive impregnation was required to prepare catalyst samples, which involves rotary evaporation, vacuum drying and pyrolysis. This method is also complicated and time-consuming, which does not allow efficient preparation of the catalyst.

Another conventional method is known for the confinement of ε-Fe₂C in graphene layers for improved stability at high temperatures. While this method is less complex than the above two methods, it still requires pyrolysis with urea and glucose. Urea is toxic and hazardous to humans, thus resulting in an additional health hazard during the synthesis process.

Another conventional method for the synthesis of iron-based catalyst promoted systems with Group 11 and 13 metals, of which indium displays a significantly better effect on C₂-C₄ olefin selectivity than gallium. However, the nature of the active phase (which is theorized to be an iron carbide) is unknown. Thus, it is unclear whether ε-Fe₂C or any other iron carbide is formed by this method.

Accordingly, there is a need for a catalyst precursor, a catalyst and methods of preparing the same that ameliorate or address one or more disadvantages as mentioned above.

### SUMMARY

In one aspect, there is provided a method of forming a catalyst precursor, comprising the steps of:
(a) forming a precipitate from a slurry, wherein the slurry comprises (i) a mixture of an iron precursor, at least one promotor precursor and a solvent and (ii) a solution of an alkali base; and
(b) calcining the precipitate to form the catalyst precursor.

In another aspect, there is provided a catalyst precursor comprising iron oxide, at least one promoter and a salt.

In another aspect, there is provided a method of forming a catalyst, comprising the step of carburizing the catalyst precursor as described herein.

In another aspect, there is provided a catalyst comprising ε-Fe₂C, an alkali metal element and at least one additional metal.

In another aspect, there is provided a process of converting COₓ and H₂ into hydrocarbons using the catalyst as described herein, wherein x is 1 or 2

### Definitions

The following words and terms used herein shall have the meaning indicated:

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

The term “about” as used herein typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of a method of forming a catalyst precursor will now be disclosed.

The method comprises the steps of:
(a) forming a precipitate from a slurry, wherein the slurry comprises (i) a mixture of an iron precursor, at least one promotor precursor and a solvent and (ii) a solution of an alkali base; and
(b) calcining the precipitate to form the catalyst precursor.

The forming step (a) may comprise the steps of:
(a1) mixing the iron precursor, the at least one promotor precursor and the solvent to form the mixture;
(a2) adding the solution of the alkali base into the mixture of step (a1) to form the slurry.

The catalyst precursor formed by the method may be reduced and activated (such as by carburizing) in situ, after which an active ε-Fe₂C phase is formed.

Advantageously, the catalyst precursor is prepared from a promotor precursor, which allows the method to proceed under gentle conditions with high operational simplicity. Accordingly, the present method does not require the use of hazardous organic chemicals such as urea. The present method also does not require harsh synthesis steps such as repeated leaching or pyrolysis.

In the forming step (a), the iron precursor may be an iron salt. The iron precursor may be selected from the group consisting of iron (III) nitrate, iron (III) chloride, iron (III) sulfate, iron (II) nitrate, iron (II) chloride, iron (II) sulfate and combinations thereof. The iron precursor may be iron (III) nitrate.

In the forming step (a), the at least one promoter precursor may be a salt of a metal selected from the group consisting of cobalt, nickel, gallium, germanium, indium, tin, zinc, cadmium, antimony, titanium, manganese and combinations and hydrates thereof. In one example, the at least one promotor precursor may comprise a cobalt salt. Where a cobalt salt is included, the catalyst precursor formed by the method may have a higher CO₂ conversion rate when activated. In another example, the at least one promoter precursor may comprise a gallium salt. Non-limiting examples of the salt include a nitrate salt, a chloride salt, a sulfate salt and combinations thereof. The salt may be a nitrate salt.

In the forming step (a), the mixture may comprise at least two promoter precursors. The at least two promoter precursors may be independently selected from the lists of metal and salt above and in one example, the at least two promoter precursors may include cobalt (III) nitrate and gallium (III) nitrate, or their hydrates thereof. The at least two promoter precursors may be provided at a molar ratio in the range of about 16:1 to about 20:1, about 16:1 to about 18:1 or about 18:1 to about 20:1. In the example where the at least two promoter precursors include (or where the two promoter precursors are) cobalt (III) nitrate and gallium (III) nitrate, the molar ratio between cobalt (III) nitrate and gallium (III) nitrate, or their hydrates thereof, may be about 16:1 to about 20:1, or about 18:1.

In the forming step (a), the mixture may additionally comprise an additive. Therefore, the method may further comprise a step of:
(a3) adding an additive to the mixture after said mixing step (a1) but before said adding step (a2).

The additive may improve heat conductivity of the catalyst precursor. The additive may be silicon carbide or graphite.

In the forming step (a), the solvent may be water.

In the mixture of the forming step (a), the iron precursor may have a concentration in the range of about 0.2 M to about 1.2 M, about 0.2 M to about 0.6 M, about 0.2 M to about 0.4 M, about 0.4 M to about 1.2 M, about 0.6 M to about 1.2 M or about 0.4 M to about 0.6 M. The concentration of the iron precursor may be about 0.5 M.

In the mixture of the forming step (a), the at least one promoter precursor may have a concentration in the range of about 0.05 M to about 0.6 M, about 0.2 M to about 0.6 M, about 0.4 M to about 0.6 M, about 0.05 M to about 0.4 M or about 0.05 M to about 0.2 M. The concentration of the at least one promoter precursor may be about 0.2 M. Where at least two promoter precursors are present, the at least two promoter precursors may have a combined concentration in the range of about 0.05 M to about 0.6 M, about 0.2 M to about 0.6 M, about 0.4 M to about 0.6 M, about 0.05 M to about 0.4 M or about 0.05 M to about 0.2 M. The combined concentration of the at least two promoter precursors may be about 0.2 M.

In the mixture of the forming step (a), the additive (where present) may have a concentration in the range of about 5 mM to about 7 mM, about 5 mM to about 6 mM or about 6 mM to about 7 mM. The concentration of the additive may be about 6 mM.

In the forming step (a), the solution of the alkali base may comprise an alkali base and a solvent.

In the solution of the alkali base, non-limiting examples of the alkali base include potassium hydroxide, sodium hydroxide, cesium hydroxide, rubidium hydroxide, lithium hydroxide and combinations thereof.

In the solution of the alkali base, the alkali base may have a concentration in the range of about 0.4 M to about 0.6 M, about 0.4 M to about 0.5 M or about 0.5 M to about 0.6 M. The concentration of the base may be about 0.5 M.

In the solution of the alkaline base, the solvent may be water.

In the forming step (a), the solution of the alkali base and the mixture may have a weight ratio in the range of about 1:0.1 to about 1:10 about 1:0.1 to about 1:3, about 1:0.1 to about 1:1, about 1:1 to about 1:10, about 1:3 to about 1:10 or about 1:1 to about 1:3. The weight ratio between the solution of the alkali base and the mixture of step (a) may be about 1:2.

The forming step (a) may comprise the steps of heating and drying the slurry to form the precipitate. The heating of the slurry may be undertaken with constant mixing, such as stirring.

In the forming step (a), the slurry may be heated at a temperature in the range of about 60° C. to about 90° C., about 70° C. to about 90° C., about 80° C. to about 90° C., about 60° C. to about 80° C. or about 60° C. to about 70° C.

In the forming step (a), the slurry may be heated for a duration in the range of about 6 hours to about 10 hours, about 6 hours to about 8 hours or about 8 hours to about 10 hours. The slurry of may be alternatively or additionally heated until it is dry.

The precipitate of the forming step (a) may undergo a filtering step before the calcining step (d). Therefore, the method may further comprise a step of:
(a4) filtering the precipitate before said calcining step (b).

In the calcining step (b), the precipitate may be calcined at a calcining temperature in the range of about 200° C. to about 500° C., about 300° C. to about 500° C., about 400° C. to about 500° C., about 200° C. to about 400° C. or about 200° C. to about 300° C. The calcining temperature may be about 450° C.

In the calcining step (b), the calcining temperature may be reached by heating at a ramp rate in the range of about 1° C./minute to about 10° C./minute, about 4° C./minute to about 10° C./minute, 7° C./minute to about 10° C./minute, 1° C./minute to about 7° C./minute or about 1° C./minute to about 4° C./minute. The ramp rate may be about 3° C./minute.

In the calcining step (b), the precipitate may be calcined for a duration in the range of about 3 hours to about 8 hours, about 5 hours to about 8 hours or about 3 hours to about 5 hours. The precipitate may be calcined for a duration of about 4 hours.

In the calcining step (b), the precipitate may be calcined in static air. After the calcining step, the iron precursor may be converted to iron oxide in the catalyst precursor. The metal of the promoter precursor may be converted to a metal oxide in the catalyst precursor. The alkali base may be converted to a salt in the catalyst precursor. The additive may retain its original chemical formula in the catalyst precursor.

Exemplary, non-limiting embodiments of a catalyst precursor will now be disclosed. The catalyst precursor comprises iron oxide, at least one promoter and a salt.

The catalyst precursor may also be referred to as a calcined catalyst. The catalyst precursor may be reduced and activated (such as by carburizing) in situ, after which an active ε-Fe₂C phase is formed.

In the catalyst precursor, the iron oxide may be hematite (Fe₂O₃), Fe₃O₄ or a combination thereof.

In the catalyst precursor, the at least one promoter may be a metal oxide of a metal selected from the group consisting of cobalt, nickel, gallium, germanium, indium, tin, zinc, cadmium, antimony, titanium, manganese and combinations thereof. Where the metal is a combination of the above, the metal oxide may be regarded as a bimetallic oxide, a trimetallic oxide, and the like. In one example, the at least one promoter precursor may comprise a cobalt oxide. The cobalt oxide may be Co₂O₃, Co₃O₄, or combinations thereof. Where Co₃O₄ is included in the catalyst precursor, the catalyst precursor may advantageously have a higher CO₂ conversion rate when activated. In another example, the at least one promoter precursor may comprise a gallium oxide, such as Ga₂O₃.

In the catalyst precursor, the iron oxide and the at least one promoter may have a molar ratio in the range of about 1:0.01 to about 1:0.28, about 1:0.1 to about 1:0.28, about 1:0.2 to about 1:0.28, about 1:0.01 to about 1:0.2 or about 1:0.01 to about 1:0.1.

The catalyst precursor may comprise at least two promoters. The at least two promoters may be independently selected from the list of metal oxide above and in one example, the at least two promoters may include Co₃O₄ and Ga₂O₃. The at least two promoters may be provided at a molar ratio in the range of about 16:1 to about 20:1, about 16:1 to about 18:1 or about 18:1 to about 20:1. In the example where the at least two promoters include (or where the two promoters are) Co₃O₄ and Ga₂O₃, the molar ratio between Co₃O₄ and Ga₂O₃ may be about 16:1 to about 20:1, or about 18:1.

Where the catalyst precursor comprises at least two promoters, the iron oxide and the combination of the at least two promoters may have a molar ratio in the range of about 1:0.01 to about 1:0.28, about 1:0.1 to about 1:0.28, about 1:0.2 to about 1:0.28, about 1:0.01 to about 1:0.2 or about 1:0.01 to about 1:0.1.

The catalyst precursor may further comprise an additive. The additive may improve heat conductivity of the catalyst precursor. The additive may be silicon carbide or graphite.

In the catalyst precursor, the iron oxide and the additive (where present) may have a molar ratio in the range of about 60:1 to about 100:1, about 60:1 to about 80:1 or about 80:1 to about 100:1. The concentration between the iron oxide and the additive may be about 80:1.

In the catalyst precursor, the salt may comprise an alkali metal cation selected from potassium, sodium, cesium, rubidium, lithium and combinations thereof. The salt may comprise an anion selected from nitrate, chloride, sulfate, hydroxide and combinations thereof. The salt may be potassium nitrate.

In the catalyst precursor, the iron oxide and the salt may have a molar ratio in the range of about 1:0.2 to about 1:0.5, about 1:0.3 to about 1:0.5, about 1:0.4 to about 1:0.5, about 1:0.2 to about 1:0.4, about 1:0.2 to about 1:0.3 or about 1:0.3 to about 1:0.4. The molar ratio between the iron oxide and the salt may be about 1:0.35.

The catalyst precursor may be prepared by the method as described herein.

Exemplary, non-limiting embodiments of a method of forming a catalyst will now be disclosed.

The method comprises the step of carburizing the catalyst precursor as described herein.

In the carburizing step, the catalyst precursor is also reduced, thus the carburizing step can be regarded as a single step where both reduction and carburisation occur.

Therefore, the method of forming the catalyst may comprise the steps of:
(a) forming a precipitate from a slurry, wherein the slurry comprises (i) a mixture of an iron precursor, at least one promotor precursor and a solvent and (ii) a solution of an alkali base; and
(b) calcining the precipitate to form a catalyst precursor; and
(c) carburizing the catalyst precursor from step (b) to form said catalyst.

In an example, the method of forming the catalyst may comprise the steps of:
(a) mixing an iron precursor, at least one promotor precursor and a solvent to form a mixture;
(b) adding a solution of an alkali base into the mixture of step (a) to form a slurry;
(c) forming a precipitate from the slurry of step (b);
(d) calcining the precipitate of step (c) to form a catalyst precursor; and
(e) carburizing the catalyst precursor from step (d) to form said catalyst.

The catalyst formed by the method may also be referred to as an active phase. The catalyst formed by the method may comprise a general metallic phase (inclusive of alloys). Therefore, the carburizing step may also be referred to as reducing and activating the catalyst precursor, after which the active phase is formed.

Advantageously, the carburizing step may be undertaken using a combination of CO and H₂. Therefore, this may be undertaken in situ before the catalyst is applied in a Fischer-Tropsch reaction, where CO and H₂ are used. No additional activating steps are needed.

Further advantageously, the carburizing step may be undertaken with a variety of conditions, such as using a gas mixture comprising at least about 50 volume % of H₂ or at least about 60 volume % of H₂. Where H₂ has the high volume percentage in the gas mixture as described above, the active ε-Fe₂C phase may be formed more efficiently.

Still further advantageously, the catalyst formed by the method may be stable at a temperature of at least about 200° C. This is due to the at least one promoter promoting an open structure for iron, while the alkali base comprises an alkali metal cation that promotes CO dissociation in the carburizing step to provide a carbon source for the catalyst. Thus, the catalyst has a more open structure than conventional iron carbides such as Fe₅C₂, with more proportion of carbon atoms in it. The at least one promoter may intercalate within the catalyst's iron structure, without which the catalyst may convert to conventional iron carbides such as Fe₅C₂ at the high temperature as defined above.

The method may further comprise a step of diluting the catalyst precursor as described herein with a catalyst support before the carburizing step.

Non-limiting examples of the catalyst support include silicon carbide, silica, carbon, alumina and combinations thereof.

The catalyst support may be silicon carbide having a size in the range of about 0.1 μm to 500 μm.

In the diluting step, the catalyst precursor as described herein and the catalyst support may be mixed at a volume ratio in the range of about 2:1 to about 1:2, about 2:1 to about 1:1 or about 1:1 to about 1:2. The volume ratio between the catalyst precursor and the catalyst support may be about 1:1.

The method may further comprise a step of reducing the catalyst precursor before the carburizing step.

The reducing step may be undertaken by placing the catalyst precursor as described herein in a reducing atmosphere. The reducing atmosphere may be a H₂ atmosphere. The reducing atmosphere may further comprise CO or H₂S. The reducing atmosphere may have a gauge pressure in the range of about 0 MPa to about 3 MPa, about 1 MPa to about 3 MPa, about 2 MPa to about 3 MPa, about 0 MPa to about 2 MPa, about 0 MPa to about 1 MPa or about 0.1 MPa to about 0.15 MPa. The gauge pressure of the reducing atmosphere may be about 0.1 MPa.

The reducing step may be undertaken at a reducing temperature of above 300° C. The reducing temperature may be in the range of about 400° C. to about 600° C., about 500° C. to about 600° C. or about 400° C. to about 500° C. The reducing temperature may be about 400° C.

The reducing temperature may be reached by heating at a ramp rate in the range of about 1° C./minute to about 10° C./minute, about 4° C./minute to about 10° C./minute, about 7° C./minute to about 10° C./minute, about 1° C./minute to about 7° C./minute or about 1° C./minute to about 4° C./minute. The ramp rate may be about 3° C./minute.

The reducing step may be undertaken for a duration in the range of about 2 hours to about 24 hours, about 12 hours to about 24 hours or about 2 hours to about 12 hours. The duration may be about 10 hours.

In the method, the carburizing step may be undertaken by placing the catalyst precursor in a carbon-containing reducing atmosphere. The carbon-containing reducing atmosphere may comprise CO, CO₂, C₁-C₄ hydrocarbons or a combination thereof. The carbon-containing reducing atmosphere may be a combination of H₂ and CO at a volume ratio in the range of about 1:0.01 to about 1:99.9, about 1:1 to about 1:99.9 or about 1:0.01 to about 1:1. The volume ratio between H₂ and CO may be about 2:1.

The carbon-containing reducing atmosphere may have a gauge pressure in the range of about 0 MPa to about 10 MPa, about 0 MPa to about 1 MPa or about 1 MPa to about 10 MPa. The gauge pressure of the carbon-containing reducing atmosphere may be about 1 MPa.

In the method, the carburizing step may be undertaken at a carburizing temperature in the range of about 100° C. to about 400° C., about 200° C. to about 400° C., about 300° C. to about 400° C., about 100° C. to about 300° C. or about 100° C. to about 200° C. The carburizing temperature may be about 300° C.

The carburizing temperature may be reached by heating at a ramp rate in the range of about 1° C./minute to about 10° C./minute, about 4° C./minute to about 10° C./minute, about 7° C./minute to about 10° C./minute, about 1° C./minute to about 7° C./minute or about 1° C./minute to about 4° C./minute. The ramp rate may be about 2° C./minute.

In the method, the carburizing step may be undertaken for a duration in the range of about 2 hours to about 50 hours, about 25 hours to about 50 hours or about 2 hours to about 25 hours. The duration may be about 24 hours.

In the method, the diluting step (where present), the reducing step (where present) and the carburizing step may be undertaken in a reactor tube, a continuous flow system, a slurry bed reactor or a fluidized bed reactor where gas may be introduced and the catalyst may be heated.

The catalyst formed by the method may be ε-Fe₂C.

Exemplary, non-limiting embodiments of a catalyst will now be disclosed.

The catalyst comprises ε-Fe₂C, an alkali metal element and at least one additional metal.

The catalyst may also be referred to as an active phase. The catalyst may comprise a general metallic phase (inclusive of alloys). The catalyst may further comprise iron that is not in the form of ε-Fe₂C (such as iron oxides).

Advantageously, the catalyst may be stable at a temperature of at least about 200° C. This is due to the at least one additional metal promoting an open structure for iron, while the alkali metal element promotes CO dissociation in the carburizing step to provide a carbon source for the catalyst. Thus, the catalyst has a more open structure than conventional iron carbides such as Fe₅C₂, with more proportion of carbon atoms in it. The additional metal may intercalate within the catalyst's iron structure, without which the catalyst may convert to conventional iron carbides such as Fe₅C₂ at the high temperature as defined above.

In the catalyst, the additional metal may be selected from the group consisting of cobalt, nickel, gallium, germanium, indium, tin, zinc, cadmium, antimony, titanium, manganese and combinations thereof. In one example, the additional metal may be cobalt. Advantageously, the catalyst may have a higher CO₂ conversion rate when the additional metal is or comprises cobalt. In another example, the additional metal may be gallium.

In the catalyst, the ε-Fe₂C and the additional metal may have a molar ratio in the range of about 1:0.01 to about 1:0.28, about 1:0.1 to about 1:0.28, about 1:0.2 to about 1:0.28, about 1:0.01 to about 1:0.2 or about 1:0.01 to about 1:0.1.

The catalyst may comprise at least two additional metals. The at least two metals may be independently selected from the list of metal above and in one example, the at least two metals may include cobalt and gallium. The at least two metals may be provided at a molar ratio in the range of about 16:1 to about 20:1, about 16:1 to about 18:1 or about 18:1 to about 20:1. In the example where the at least two metals include (or where the two metals are) cobalt and gallium, the molar ratio between cobalt and gallium may be about 16:1 to about 20:1, or about 18:1.

Where the catalyst comprises at least two metals, the ε-Fe₂C and the combination of the at least two metals may have a molar ratio in the range of about 1:0.01 to about 1:0.28, about 1:0.1 to about 1:0.28, about 1:0.2 to about 1:0.28, about 1:0.01 to about 1:0.2 or about 1:0.01 to about 1:0.1.

The catalyst may further comprise an additive. The additive may improve heat conductivity of the catalyst precursor. The additive may be silicon carbide or graphite.

In the catalyst, the ε-Fe₂C and the additive (where present) may have a molar ratio in the range of about 60:1 to about 100:1, about 60:1 to about 80:1 or about 80:1 to about 100:1. The molar ratio between the ε-Fe₂C and the additive may be about 80:1.

In the catalyst, the alkali metal element may be sodium, potassium, cesium, rubidium, lithium or a combination thereof.

In the catalyst, the total amount of iron and the alkali metal element may have a molar ratio in the range of about 1:0.2 to about 1:0.5, about 1:0.3 to about 1:0.5, about 1:0.4 to about 1:0.5, about 1:0.2 to about 1:0.4, about 1:0.2 to about 1:0.3 or about 1:0.3 to about 1:0.4. The molar ratio between the total amount of iron and the alkali metal element may be about 1:0.35.

The catalyst may further comprise a catalyst support.

Non-limiting examples of the catalyst support include silicon carbide, silica, carbon, alumina and combinations thereof.

The catalyst support may be silicon carbide having a size in the range of about 0.1 μm to 500 μm.

Where the catalyst support is present, the catalyst support may have a volume ratio of about 50% based on the total volume of the catalyst.

The catalyst may have a formula of KₐFe_{b}Co_{c}-Ga_{d}-(SiC)ₑ, wherein
a is a number in the range of 0.01 to 0.5;
b is 1;
c is a number in the range of 0 to 0.5;
d is a number in the range of 0 to 0.3; and
e is a number in the range of 0 to 0.1,
with the proviso that c+d is larger than 0, and
the catalyst is overall neutral in electric charge.

The catalyst may be prepared by the method as described herein.

Exemplary, non-limiting embodiments of a process of converting COₓ and H₂ into hydrocarbons will now be disclosed.

The process uses the catalyst as described herein, wherein x is 1 or 2.

The process may be undertaken in a reactor tube, a continuous flow system, a slurry bed reactor or a fluidized bed reactor where gas may be introduced and the catalyst may be heated.

The H₂ and the COₓ may have a volume ratio in the range of about 1:2 to about 5:1, about 2:1 to about 5:1 or about 1:2 to about 2:1. The volume ratio between the H₂ and the COₓ may be about 3:1.

The H₂ and the COₓ may have a combined gauge pressure in the range of about 0 MPa to about 10 MPa, about 3 MPa to about 10 MPa or about 0 MPa or about 3 MPa. The combined gauge pressure may be about 3 MPa.

The H₂ and the COₓ may flow through the catalyst as described herein at a flow rate that is less than or equal to 20000 cm³·g·cat⁻¹·h⁻¹. The flow rate may be in the range of about 1500 cm³·g·cat⁻¹·h⁻¹ to about 2500 cm³·g·cat⁻¹·h⁻¹, about 1500 cm³·g·cat⁻¹·h⁻¹ to about 2000 cm³·g·cat⁻¹·h⁻¹ or about 2000 cm³·g·cat⁻¹·h⁻¹ to about 2500 cm³·g·cat⁻¹·h⁻¹. The flow rate may be about 2000 cm³·g·cat⁻¹·h⁻¹.

The process may be undertaken at a reaction temperature in the range of about 180° C. to about 400° C., about 280° C. to about 400° C. or about 180° C. to about 280° C. The reaction temperature may be about 280° C.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

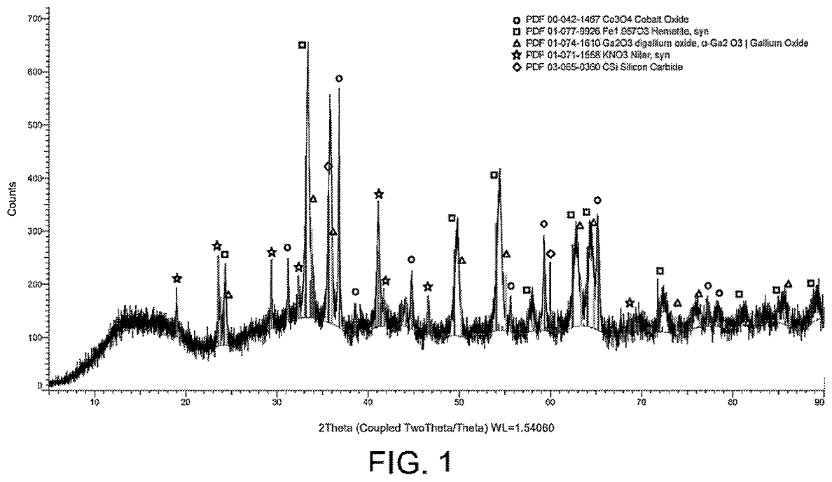

### FIG. 1

FIG. 1 shows X-ray diffraction patterns of a catalyst precursor according to one embodiment of the present disclosure.

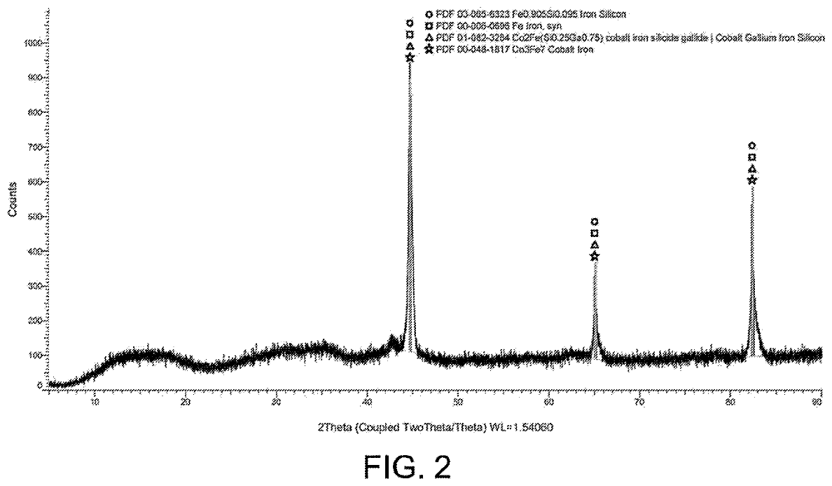

### FIG. 2

FIG. 2 shows X-ray diffraction patterns of a reduced catalyst precursor according to one embodiment of the present disclosure.

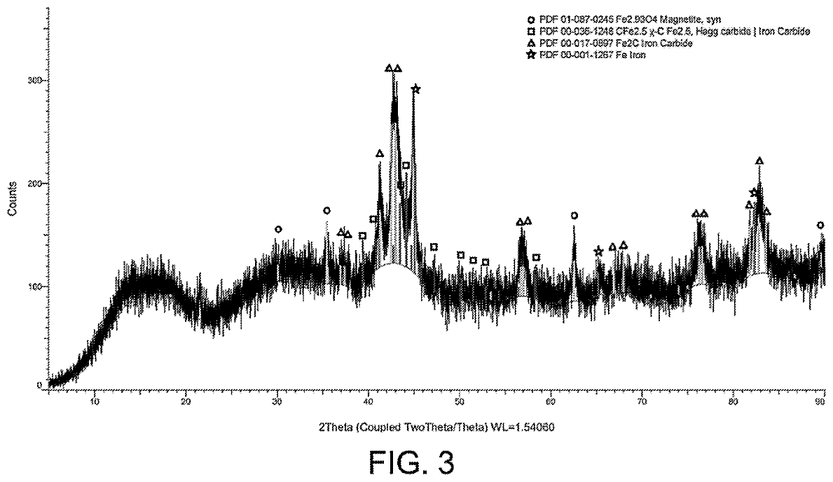

### FIG. 3

FIG. 3 shows X-ray diffraction patterns of a catalyst according to one embodiment of the present disclosure.

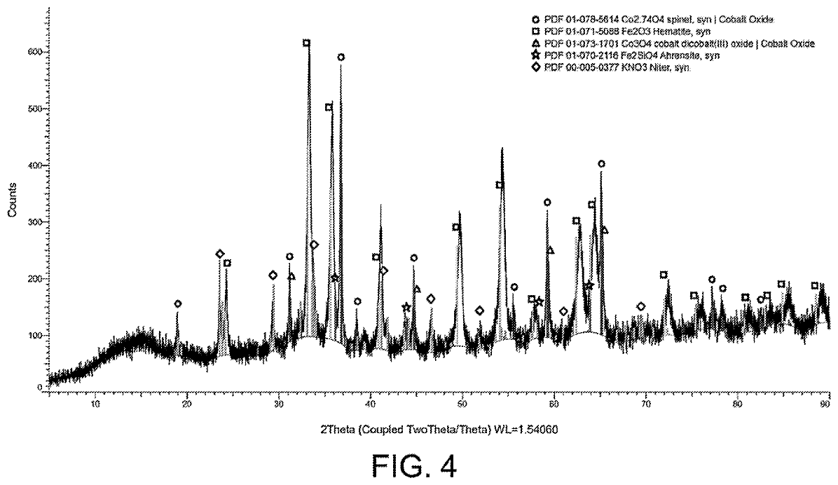

### FIG. 4

FIG. 4 shows X-ray diffraction patterns of a catalyst precursor which does not comprise a promotor.

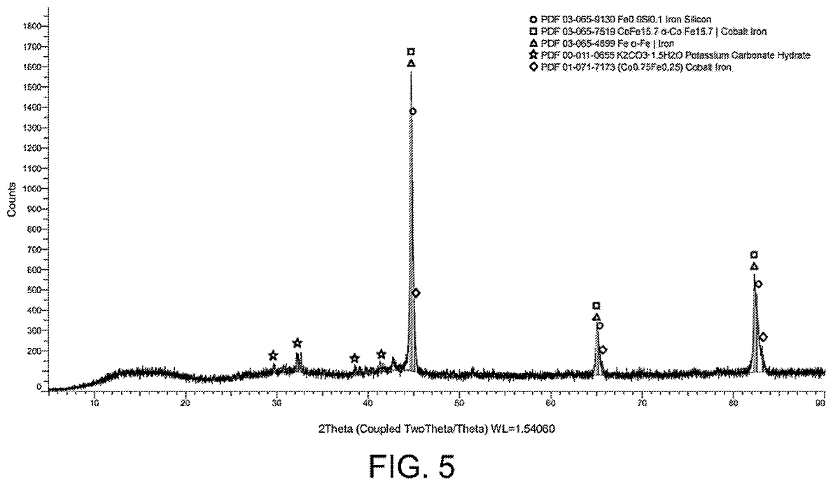

### FIG. 5

FIG. 5 shows X-ray diffraction patterns of a reduced catalyst precursor which does not comprise a promotor.

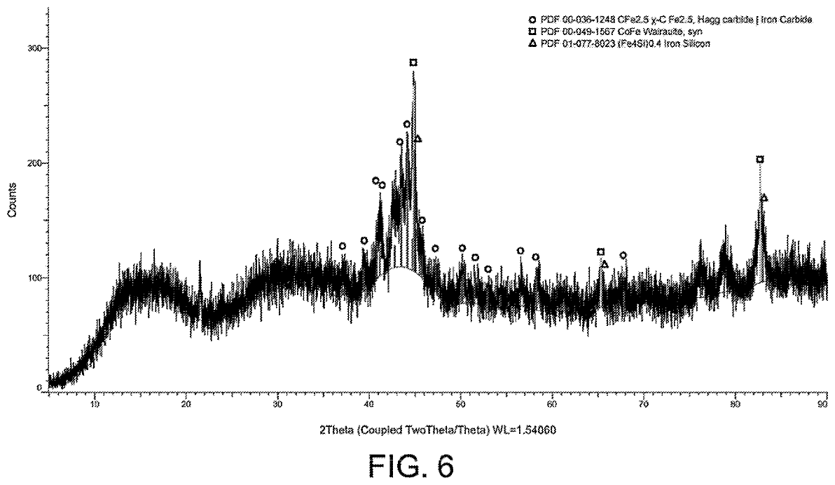

### FIG. 6

FIG. 6 shows X-ray diffraction patterns of a catalyst formed from a catalyst precursor which does not comprise a promotor.

### EXAMPLES

Non-limiting examples of the invention will be further described in greater detail by reference to specific Examples, which should not be construed as in any way limiting the scope of the invention.

### Example 1—Preparation of Catalyst

Generally, a gallium-promoted iron-based catalyst according to the present disclosure was prepared through a co-precipitation technique. Particularly, the following components were combined and dissolved in 100 ml of water (purchased from Sigma Aldrich, Singapore) in a beaker: iron (III) nitrate nonahydrate-20 g (purchased from Sigma Aldrich, Singapore), cobalt (III) nitrate hexahydrate-7.02 g (purchased from Sigma Aldrich, Singapore), gallium (III) nitrate nonahydrate-0.492 g (purchased from Sigma Aldrich, Singapore) and silicon carbide-0.025 g (purchased from Sigma Aldrich, Singapore). The solution formed was stirred thoroughly and then precipitated with 1.39 g of potassium hydroxide (purchased from Sigma Aldrich, Singapore) dissolved in 50 ml of water. The resultant precipitate slurry was heated gently and stirred overnight to dry. The precipitate obtained was then removed from the beaker by filtration and calcined at 450° C. in static air for 4 hours (ramp rate: 3° C./minute) to form a catalyst precursor.

After calcination, the catalyst precursor was subjected to an in-situ pre-treatment process that comprised of reduction and activation. Reduction and activation were carried out in-situ before Fischer-Tropsch synthesis (FTS) testing. Reduction was carried out in H₂ at ambient pressure and 400° C. for 10 hours (ramp rate: 3° C./minute). Activation was carried out with syngas (H₂/CO=2) at 1 MPa and 300° C. for 24 hours (ramp rate: 2° C./minute).

### Example 2—Characterization of Catalyst

To identify crystalline phases present in the catalyst at various stages of the process of formation, X-ray diffraction (XRD) characterization was carried out for the catalyst precursor, reduced catalyst precursor and pre-treated (or activated) catalyst precursor (which is the catalyst) samples with a Bruker D8 Advance X-Ray Diffractometer.

As described in Example 1, the reduction and activation steps were carried out in-situ in a reactor tube before the commencement of FTS testing. Reduction was carried out in H₂ at ambient pressure and 400° C. for 10 hours (ramp rate: 3° C./minute). Activation was carried out with syngas (H₂/CO=2) at 1 MPa and 300° C. for 24 hours (ramp rate: 2° C./minute).

With reference to FIG. 1, the catalyst precursor had crystal structures of a combination of hematite (Fe₂O₃), cobalt (II, III) oxide (Co₃O₄), gallium oxide (Ga₂O₃) and potassium nitrate (KNO₃), as identified by XRD.

After undergoing a reducing step, oxides in the catalyst precursor were reduced to an alloy phase. With reference to FIG. 2, XRD characterization showed peaks of alloys formed from the metals present (Fe, Co, Ga and Si). No carbide phase was present before activation with syngas, as was expected by the inventors.

With reference to FIG. 3, after activation with syngas, carburization of the catalyst precursor resulted in a change of its overall composition to Fe₂C and a small amount of Fe₅C₂ (Hagg carbide), as well as pure iron. This showed that the formation of iron carbide phases was a direct result of the carburization process that the catalyst precursor underwent during activation.

### Comparative Example 1—Preparation and Characterization of Catalyst without Gallium Dopant

For comparison purposes, a catalyst sample was also prepared without the gallium dopant that was used as described in Example 1 (gallium (III) nitrate nonahydrate). The remaining preparation steps and characterization processes are the same as described in Examples 1 and 2.

With reference to FIGS. 4 to 6, XRD results of the catalyst without gallium dopant similarly reflected a crystal structure of hematite and cobalt oxide before reduction and pretreatment. However, there was only Hagg carbide without Fe₂C after pre-treatment (or activation). Therefore, it was evident that the gallium dopant played a vital role in the formation of the Fe₂C carbide phase.

### Example 3—Fischer-Tropsch Synthesis (FTS) Catalysis Test

Catalysis tests were carried out by conducting Fischer-Tropsch synthesis (FTS) in an Imtech customised fixed-bed reactor system with a 14 mm diameter RA330 alloy reactor tube. 1.0 g of each catalyst was diluted with SiC having a size of 500 μm in a 1:1 volume ratio before being loaded into the reactor.

Subsequently, reduction and activation were carried out in-situ before FTS testing, as described in Example 1. Briefly, reduction was carried out in H₂ at ambient pressure and 400° C. for 10 hours (ramp rate: 3° C./minute). Activation was carried out with syngas (H₂/CO=2) at 1 MPa and 300° C. for 24 hours (ramp rate: 2° C./minute).

After reduction and activation were completed, the reactor was cooled to ambient temperature and pressurized to 3 MPa. The reactor was then heated to 280° C. for FTS test using CO₂ and H₂ (H₂/CO₂₌₃) at a gas hourly space velocity (GHSV) of 2000 cm³gcat⁻¹h⁻¹.

The composition of the outlet gases was analyzed using an online gas chromatography (GC: Agilent, 8890). Using the data obtained from the GC, the key parameters were calculated and catalytic performance was evaluated in terms of CO₂ conversion and the selectivity of the hydrocarbons across the hydrocarbon range, as shown in Table 1 below.

TABLE 1
FTS activity comparison of the catalyst as described in Example 1 (KFeCo—Ga—SiC)
and the catalyst as described in Comparative Example 1 (KFeCo—SiC)
Reaction Conditions: T = 280° C., P = 30 bar, GHSV = 2000 cm³gcat⁻¹h⁻¹

| | X | S | S | S | S | Yield | Yield |
|---|---|---|---|---|---|---|---|
| Catalyst | (CO₂) | (CH₄) | (CO) | (C2-4) | (C5+) | (C2-4) | (C5+) |
| KFeCo—Ga—SiC | 35.0 | 23.0 | 10.0 | 34.6 | 32.4 | 12.0 | 11.3 |
| KFeCo—SiC | 22.6 | 25.2 | 28.2 | 18.4 | 28.2 | 4.2 | 6.4 |

Catalyst test showed that the present catalyst (which was doped with gallium) displayed a significant improvement over the catalyst without gallium dopant, as evidenced by the superior CO₂ conversion and C5+ yield. This was in agreement with the findings of other reported studies that the Fe₂C phase (which was not present in the catalyst without gallium dopant, as shown by XRD characterization) had a higher catalytic activity than the more commonly observed Fe₅C₂ (Hagg carbide) phase.

### INDUSTRIAL APPLICABILITY

The catalyst of the disclosure may be used in a variety of applications such as conversion from CO or CO₂ to fuels or chemicals.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A method of forming a catalyst precursor, comprising the steps of:
(a) forming a precipitate from a slurry, wherein the slurry comprises (i) a mixture of an iron precursor, at least one promotor precursor and a solvent and (ii) a solution of an alkali base; and
(b) calcining the precipitate to form the catalyst precursor.

2. The method of claim 1, wherein said forming step (a) comprises the steps of:
(a1) mixing the iron precursor, the at least one promotor precursor and the solvent to form the mixture;
(a2) adding the solution of the alkali base into the mixture of step (a1) to form the slurry.

3. The method of claim 1, wherein the iron precursor is selected from the group consisting of iron (III) nitrate, iron (III) chloride, iron (III) sulfate, iron (II) nitrate, iron (II) chloride, iron (II) sulfate and combinations thereof.

4. The method of claim 1, wherein the at least one promotor precursor comprises a gallium salt.

5. The method of claim 2, wherein said mixing step (a1) comprises mixing the iron precursor, at least two promotor precursors and the solvent to form the mixture.

6. The method of claim 2, further comprising a step of:
(a3) adding an additive to the mixture after said mixing step (a1) but before said adding step (a2).

7. The method of claim 1, wherein the solution of the alkali base and the mixture have a weight ratio in the range of 1:0.1 to 1:10.

8. The method of claim 2, wherein in said adding step (a2), the solution of the alkali base has a concentration in the range of 0.4 M to 0.6 M.

9. The method of claim 1, wherein said forming step (a) comprises heating and drying the slurry to form the precipitate.

10. The method of claim 1, further comprising a step of:
(a4) filtering the precipitate before said calcining step (b).

11. The method of claim 1, wherein said calcining step (b) comprises calcining the precipitate at a temperature in the range of 200° C. to 500° C.

12. A catalyst precursor comprising iron oxide, at least one promoter and a salt.

13. The catalyst precursor of claim 12, wherein the at least one promoter comprises a cobalt oxide.

14. The catalyst precursor of claim 12, wherein the catalyst precursor comprises at least two promoters.

15. (canceled)

16. The catalyst precursor of claim 12, wherein the salt comprises an alkali metal cation selected from potassium, sodium, cesium, rubidium, lithium and combinations thereof.

17. A method of forming a catalyst, comprising the step of carburizing the catalyst precursor of claim 12.

18. The method of claim 17, further comprising a step of diluting the catalyst precursor with a catalyst support before the carburizing step.

19. The method of claim 17, further comprising a step of reducing the catalyst precursor before the carburizing step.

20. A catalyst comprising ε-Fe₂C, an alkali metal element and at least one additional metal.

21. A process of converting COₓ and H₂ into hydrocarbons using the catalyst of claim 20, wherein x is 1 or 2.
